(19) United States
(12) Patent Application Publication
(10) Pub. No.: US 2012/0196006 A1
(43) Pub. Date: Aug. 2, 2012

(54) POWDER COATING PARTICLES IN CRYOGENIC BATH

(76) Inventor: Stan Jones, Metropolis, IL (US)

(21) Appl. No.: 13/359,964

(22) Filed: Jan. 27, 2012

Related U.S. Application Data
(60) Provisional application No. 61/437,141, filed on Jan. 28, 2011.

(51) Int. Cl. A23G 9/48; A23P 1/08; F28D 15/00

(52) U.S. Cl. 426/96; 165/104.23; 426/289; 426/244

(57) ABSTRACT

Embodiments of the present invention relate to a method and apparatus for coating cryogenically frozen particles, such as food particles, with a powder at least in part by random contact with the powder while the particles and powder are circulating in a liquid cryogen. The powder and/or food particles may be electrically charged to increase their affinity for one another as well as the rate of powder coating of the frozen particles.

### CROSS REFERENCE TO RELATED APPLICATIONS

This application claims priority benefit to U.S. Provisional Application No. 61/437,141, entitled “Electro-Coating Cryogenic Pellets,” filed on Jan. 28, 2011, the entire contents and disclosure of which are incorporated herein by reference.

### BACKGROUND

1. Field of the Invention

The present invention relates generally to a method and system for powder coating frozen particles, such as food particles including beaded or particulate ice cream.

2. Related Art

Ice cream products are known to be popular, and some products on the market combine ice cream shapes with various types of coatings. By adding coatings to ice cream, the number of different products and flavors that are possible may be greatly increased. However, it is often difficult and challenging to uniformly apply coatings to frozen food products, such as solid or semi-solid ice cream, at cold temperatures. This can result in coated products that are unappealing in taste, texture and/or appearance.

Thus, there is a need in the art for an improved method and system for uniformly applying coatings to frozen food products, such as ice cream. This is especially true for particulate or beaded ice cream products that are cryogenically frozen at very cold temperatures that have a tendency to stick together when stored at higher temperatures.

### SUMMARY

According to a first aspect of the present invention, a method for powder coating a food particle, comprising: (a) adding a plurality of pieces or droplets of a food mixture into a liquid cryogen bath in a container to form a plurality of cryogenically frozen food particles; and (b) coating the plurality of cryogenically frozen food particles with a powder present in the liquid cryogen. The method may further comprise (c) electrically charging the powder in the liquid cryogen via a first electrode connected to a direct current (DC) power source, wherein step (c) is performed prior to or during step (b).

According to a second aspect of the present invention, a composition is also provided comprising a plurality of food particles coated with the powder in the liquid cryogen according to the methods described herein.

According to a third aspect of the present invention, an apparatus is provided comprising a container having a top opening and configured to hold a bath of liquid cryogen; an optional feed tray disposed above or near the top of the container; and an optional first electrode connected to a power source and configured to be in electrical contact with the liquid cryogen when the liquid cryogen is added to the container, wherein the feed tray when present is configured to receive a food formulation and form a plurality of droplets of the food formulation that fall into the liquid cryogen in the container. The apparatus may further comprise a second electrode connected to the power source and configured to be in electrical contact with the food formulation. In addition, the apparatus may further comprise a powder source for delivering a powder to the container, and/or a device, such as a pump, for delivering a cryogen to the container. A computer or logic controller may be connected to the apparatus and control the amount, rate and/or timing of addition of any cryogen, food formulation and/or powder to the container and the liquid cryogen contained therein.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a flowchart of method steps according to embodiments of the present invention;

FIG. 2 is a depiction of different exemplary shapes of frozen particles or beads;

FIG. 3 is a flash freezing apparatus for cryogenically freezing droplets of a liquid formulation into beads;

FIG. 4 is a simplified apparatus powder coating frozen particles with a powder in a fluidized bed of liquid cryogen according to embodiments of the present invention; and

FIG. 5 depicts a flash freezing apparatus much like the apparatus in FIG. 3 with additional optional features in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details.

The method and system of the present invention provides a way to uniformly coat a plurality of frozen particles with a powder defined as a substance composed of fine granules. In general, a food composition, formulation or mixture is introduced into a bath or bed of a liquid cryogen or refrigerant, such as liquid nitrogen, present in a container. A powder substance is also added to the liquid cryogen bath before, during, and/or after the addition of the food mixture to the cryogen bath. As a result of its presence in the cryogen bath, the food mixture becomes frozen (if not already) into food particles by the super cold cryogenic fluid/liquid and may also be coated by the powder. As used herein, the terms “coated” and “coating” refer to the process and result of coating a particle present in a liquid cryogen bath with a powder also present in the bath. A particle, such as a frozen food particle, is “coated” by a powder when most or substantially all of its surface (e.g., greater than 90% or 95% of its surface) is covered by the powder.

Due to the rapid boiling of the liquid cryogen in the bath at higher operating temperatures, including at room temperature, a turbulent fluid flow is created that continuously and thoroughly mixes and disperses the powder and frozen food particles within the bath. This turbulence promotes the random contact of the powder with the food particles and thus even coating of the food particles with the powder. According to embodiments of the present invention, it is believed that coverage by the coating approaching about 95% or higher of the surface of the food particles may be achieved. It is also envisioned that multiple rounds of coating with the same or different powders may also be performed, which may further increase the degree of coverage to or near 100%.

Although the method and system of the present invention is primarily envisioned for use in coating frozen food products, such as cryogenically frozen ice cream particles or beads, the principles of the present invention could also be applied to non-edible products. Indeed, many different kinds or formulations of frozen particles or pellets could potentially be coated with one or more powders according to present methods. Thus, the present invention is not intended to be limited only to edible or food embodiments.

With cryogenically frozen food particles, it important to maintain its property or characteristic of being free-flowing or pourable. By evenly coating the cryogenically frozen particles or beads according to the method and system of the present invention, these particles may be less likely to stick or clump together when stored at higher temperatures. Another advantage of the present invention is that the coating of the food particles may occur under “dry” conditions in the absence of water even though the particles are being mixed with the powder coating in a fluidized cryogen bed. By dry coating in this manner, the inadvertent introduction of water to the surface of the particle during the coating process is avoided. These dry conditions may also refer to the insolubility of the powder in the cryogen, such that the powder granules are suspended in the cryogen.

The food composition, formulation or mixture added to the cryogenic liquid may include a variety of different food types or drinks. For example, the food particles may be formed by freezing mixtures or formulations of ice cream or other confectioneries. The food mixture may be previously frozen or semi-frozen prior to its addition to the bath, or it may be a liquid composition that only becomes flash frozen once introduced to the cryogen bath. It is also conceivable that the food particles may also comprise solid or semi-solid food compositions that are not previously frozen.

In accordance with the present invention, it is further contemplated that an electric charge may be applied to the liquid cryogen bath or bed to cause or induce the powder present in the bath to adopt a charge. By charging the powder, it may become more attracted to the frozen food particles present in the bath that have an opposite charge. The charge properties of these frozen food particles may be the natural result of their formulation or as a result of their charging by a separate process before being introduced to the bath. The resulting attraction and close association between the powder and the food particles will cause the powder to coat the particles. Thus, this process of electro-coating the particles may further increase the amount powder coating of the particles and/or reduce the amount of time needed to sufficiently coat the particles.

The charge may be introduced by at least one electrode present or submerged in the cryogen bath and connected to a direct current (DC) power source. The charge introduced to the cryogen bath by the electrode may be either positive or negative depending on the desired charge for the powder based on a variety of factors, such as the combination and type of powder as well as the mixture or formulation of the food particle to be coated. The exact amount of voltage that may be applied to the electrode may vary widely depending, for example, on the combination and types of food particles, powder coating, and the conducting properties of the cryogen-containing apparatus. For example, the voltage of the power source may vary from about 1 to about 50 volts for some applications. However, much larger voltages are also contemplated.

Without being bound by any theory, it is believed that the charge of the electrode(s) placed into the cryogen bath will induce a charge (i.e., an opposite charge) on the powder present in the bath when it contacts or is in close proximity to the electrode(s). Due to the violent or turbulent mixing caused by the rapid boiling of the cryogen, the powder will be made to randomly come into contact or proximity with the electrode(s) with some frequency. The attraction and association between the powder and the food particles may thus be increased as a result of the opposite charge induced on the powder.

Our recent experiments have demonstrated that powders of maltodextrin DE 10 and cocoa powder suspended in a fluidized bed of liquid nitrogen at −320° F. can become attracted and localized to either a positively or negatively charged electrode at 5, 12 or 32 volts present or submersed in the liquid nitrogen. This demonstrates that the electrode is able to induce an opposite charge on the powder granules and that the powder is able to accept the charge, and as a result, the powder granules become attracted and retained in proximity to the oppositely charged electrode. These are promising results for the ability of present methods to increase the coating of food particles with powder due to their opposite charges. Thus, it is likely that according to embodiments of the present invention, the charged powders can be made to have increased attraction for, and coating of, oppositely charged food particles.

Although the cryogen may remain relatively inert and neutrally charged during this process, there is some evidence for electrification of liquid nitrogen. See, e.g., Mizuno, Y. et al., “Streaming Electrification of Liquid Nitrogen Flowing Through Electrical Insulating Pipe,” Electrical Insulation and Dielectric Phenomena, p. 134-137 (2004), the entire contents and disclosure of which is incorporated herein by reference. As discussed therein, nitrogen has an electronegativity of 3.04 which suggests that it can easily accept electrons and be negatively charged. However, the triple covalent bond of N₂ makes it a rather stable molecule that can be either negatively or positively charged as desired.

Thus, electrodes of opposite polarity may be introduced to the cryogen bath depending on the powder and food particles to maximize their adherence to one another, and the liquid cryogen may be able to assist in this charging process in addition to the electrodes charging the powder directly. Mizuno et al. also provides that materials present in the liquid nitrogen may affect the ease of charging the liquid nitrogen to one polarity or the other. Therefore, according to some embodiments of the present invention, additional materials may be added to the container to achieve a desired charging effect. Furthermore, different voltages and charging profiles (e.g., duration and voltage) may be selected according to some embodiments to accomplish a desired coating coverage and thickness.

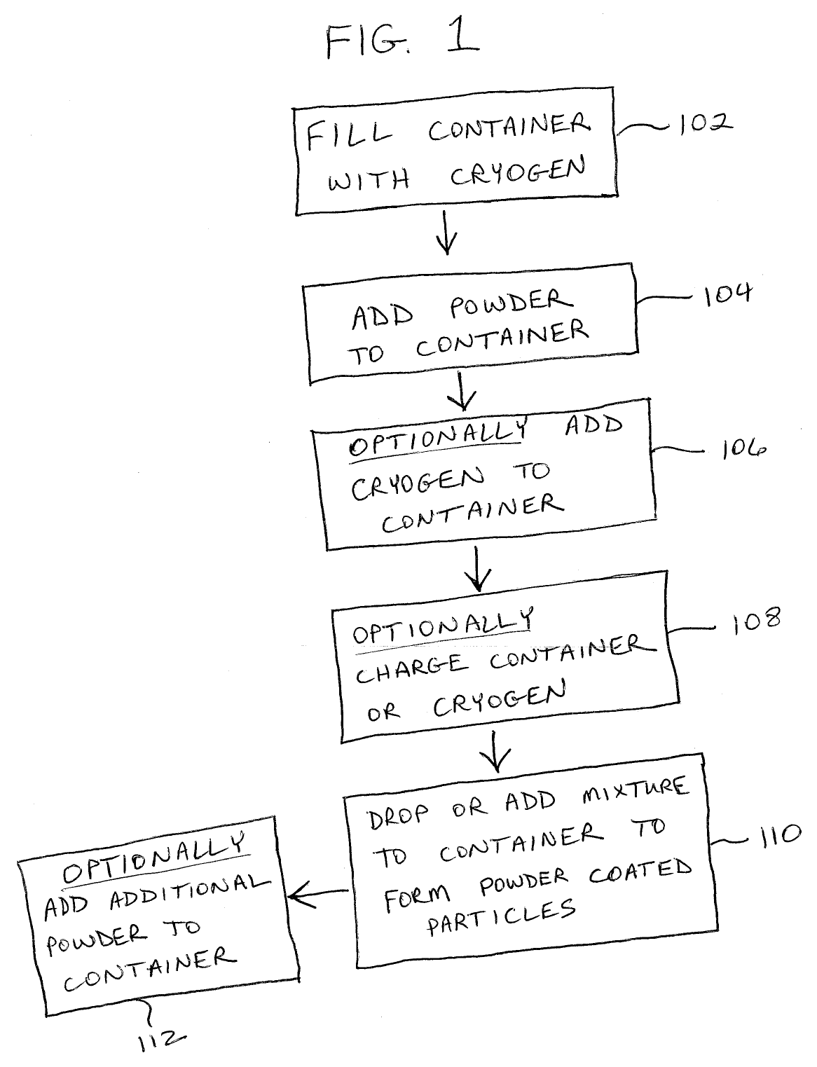

FIG. 1 depicts a flowchart of an exemplary method of powder coating food particles in accordance with the principles of the present invention. In step 102, a container may be filled (or provided) with a predetermined amount or volume of cryogen, such as liquid nitrogen. This container will be used for the coating process. In those embodiments in which a food mixture, such as a liquid formulation, is frozen into food particles, the cryogen bath in the container may serve a dual purpose of both freezing the mixture into a plurality of food particles and coating those particles with the powder.

In step 104, an amount or volume of powder may be introduced or metered into the container to become suspended and dispersed in the liquid cryogen. Alternatively, the container with the cryogenic fluid and the powder may be provided in a first step. Many different powders are contemplated within the scope of the present invention, and the size of the individual granules of powder may vary depending on the application to provide an even coating and different electro-charging properties. For example, the powder may include cocoa powder or maltodextrin. These powders generally have a pleasant taste, adhere to both dairy- and water-based frozen food particles, are not soluble in liquid nitrogen, and are available in a range of sizes and formulas (e.g., DE-5, DE-10, DE-20). DE stands for “dextrose equivalent.” Alternative powders (and combinations of powders) may also be selected that are known to have properties similar to maltodextrin and cocoa powder.

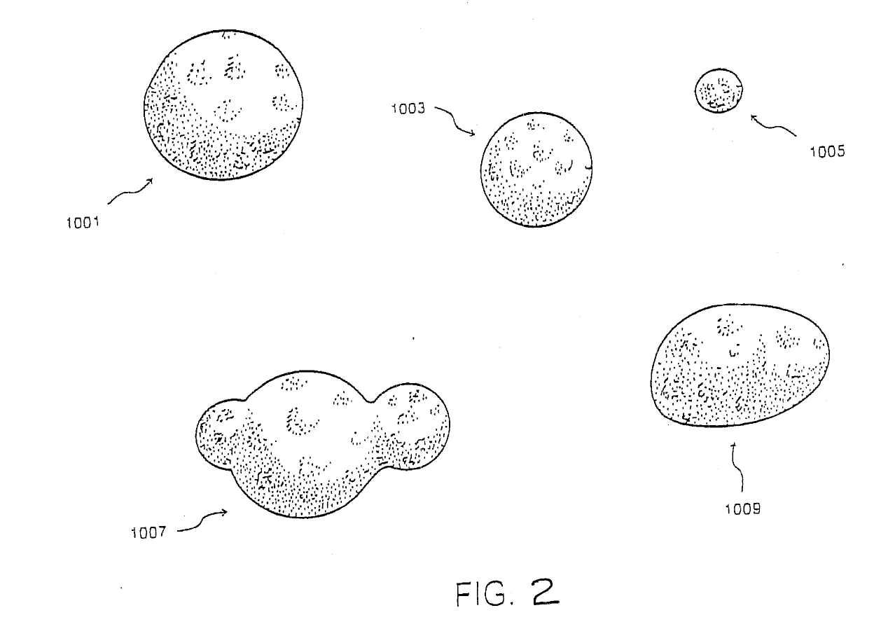

One aspect that adversely impacts the ability of food particles to remain free-flowing is the presence of numerous small craters on the surface of the particles, which are susceptible to water migration that can lead to ice crystal formation. The presence of these ice crystals then impacts the taste, mouth-feel, and free-flowing ability of the particles. According to embodiments of the present invention, one contemplated approach to address this problem is to fill these craters with a powder to minimize the exposed surface area on each of the particles. By filling these craters with a coating material, the frozen food particles may become less irregular in shape and thus more free-flowing even at higher ambient temperatures. Craters present on the surface of the food particles may be on the magnitude of microns in size. Thus, powders having granule sizes that are appropriate to fill these craters during the coating process are contemplated according to the present invention. Indeed, a diversity of powder granule sizes may be better suited at filling in uneven surfaces of food particles having different crater sizes (See, e.g., FIG. 2). According to some embodiments, a powder comprising granules of the same or different size(s) may be used, and different kinds of powders may be used together that may have the same or different granule size(s).

The powder in step 104 may also be selected to complement and enhance its adherence to the formulation of the food particles. In other words, powders more susceptible to a negative charge may be selected when paired with a formulation that has, or is more susceptible to, a positive charge (and vice versa). Thus, some of the attributes of powder that are considered when selecting the powder for a particular application include powder granule size, conductivity (or resistance) to charging, adherence qualities, polarity of the charge being applied to the powder, taste, solubility in liquid nitrogen, etc. Although only a single powder coating may be applied to the frozen food particles, more than one coating may be used simultaneously or in a series of coating steps. For example, two or more powders may be suspended simultaneously in the liquid cryogen.

In step 106, additional cryogen, such as liquid nitrogen, may optionally be added to the fluidized bed of cryogen present in the container. This may be done to replace liquid cryogen lost from the system or apparatus by evaporation. Injection of new cryogen fluid may also further increase the amount of turbulence of the fluid bed or base. The cryogen may be provided or injected at or near the bottom of the container holding the liquid cryogen and powder at one or more location(s), which may increase the distribution and suspension of the powder in the liquid cryogen. As mentioned above, increasing the turbulence of the cryogen fluid will increase the contact or interaction between the powder and any electrode(s) as well as between the powder and the frozen food particles. This will further promote the uniform adherence or coating of the powder to the surface of the food particles.

In step 108 as described herein, an electrical charge may be applied to the container, or directly to the liquid cryogen in the container, to positively or negatively charge the powder within the liquid cryogen either directly and/or at least partially via the liquid cryogen) to promote the electro-coating of the food particles with the powder. The placement, construction and charging properties of the electrodes may be used to maximize or affect the transference of electrical charge to the cryogen, mixture and/or the powder. According to embodiments of the present invention, the charge will be generated by a power source that supplies a positive or negative charge to the liquid cryogen and powder through one of two oppositely charged electrodes. The other oppositely charged electrode may either be grounded or attached elsewhere to the apparatus used in the coating process.

According to embodiments of the preset invention, one of the electrodes may be in electrical contact with either the container or liquid cryogen directly to deliver an electrical charge to the cryogen and powder to charge the powder. At the same time, the other oppositely charged electrode may be electrically connected to another portion of the same or different apparatus that comes in contact with the formulation that will be flash frozen into a plurality of frozen particles when added to the liquid cryogen in the container. As a result, a charge may be induced on, or given to, the formulation and/or frozen particles in the cryogen such that the frozen particles will be attracted to the oppositely charged powder, thus increasing the attraction and coating of the powder onto the surface of the particles.

In step 110, a plurality of droplets or units of a food mixture or composition may be added to the cryogen bath containing the powder (e.g., dripped into the bath in the case of a liquid food mixture) to form the plurality of frozen food particles that will receive the powder coating. The food formulation or mixture may contain additional ingredients that allow, augment or adjust the electrical charge of the formulation or mixture. Optionally, the food mixture may already be frozen or semi-frozen into small unit particles or shapes that may be dropped or placed into the cryogen bath at this step. In addition to freezing into a plurality of food particles, the powder may also become adhered to or coated onto the surface of these particles during this step. Indeed as mentioned above, adherence of the powder to the particles or shapes may be enhanced by the volatile and turbulent fluid flow of the bed or bath, by electro-charging the powder, or both.

Additional powder may be added or metered into the liquid cryogen in optional step 112 as needed or based on a detected or expected concentration of powder, such as to maintain a desired concentration of powder. The desired concentration of powder may be a predetermined amount and/or based on the powder's characteristics and the desired amount of coverage of the food particles.

Although the flowchart of FIG. 1 is discussed in the form of a batch process, the present invention also contemplates a continuous process for coating particulate shapes. For example, because the conductivity of the liquid cryogen may change based on the concentration of suspended powder, a conductivity sensor can be present within the container that automatically monitors the conductivity as an indication of powder concentration. Even though the method in FIG. 1 is presented as a series of steps, it is also envisioned that different combinations of these steps may be performed in a different order in accordance with the principles disclosed herein, and a combination(s) of these steps may be performed simultaneously.

According to some embodiments, a plurality of droplets of a food formulation or mixture of frozen confections, such as ice cream, ice milk, ices, or sorbet, may be introduced into a cryogen to form a plurality of small food particles or shapes. The cryogenically frozen ice cream particles may have a generally spherical or spheroid shape as shown in FIG. 2 (e.g., 1001, 1003, 1005), but may also have an oblong, elliptical, oblate, tubular, or other slightly irregular shape as also shown in FIG. 2 (e.g., 1007, 1009). In addition to having an irregular overall shape, the surface of the particulate shape may also be either smooth or irregular (e.g., bumpy, pocked, etc.). On average, the particulate shapes may preferably have a diameter of about 0.05 inch to about 0.5 inch, including about 0.4 inch, 0.3 inch, 0.25 inch, 0.2 inch, 0.15 inch, and about 0.1 inch, and ranges including and bordered by these dimensions. The frozen food particles having diameters outside these ranges (either greater than or less than) are also contemplated. For non-spherical shapes which do not have a conventional diameter, the diameter is the diameter of the smallest sphere into which the particulate shape would fit.

It is often desired that the particulate food or ice cream product (sometimes referred to as “beads”) formed by cryogenic freezing remain free-flowing so that it may be readily pourable or spoonable. “Free-flowing,” as used herein, is a broad term meaning the ability of the product to flow substantially as individual particles while being poured with little or no clumping or sticking to each other. The product may still be considered free-flowing even though there is some slight sticking together of particles after a period of storage, as long as tapping on the container will unstick the particles and allow them to become free-flowing again. A generally spherical or spheroid shape contributes to the free-flowing pourability of the product.

Once these cryogenically frozen food or ice cream particles or beads are formed, they may be stored in a freezer for a period of time for later use or consumption. Some embodiments of these frozen food particles must be stored in a specialized, low temperature freezer preferably having a temperature averaging from about −20° F. to about −40° F. to maintain its free-flowing pourability during storage. In other embodiments, however, the particulate food product may be stored at higher temperatures, such as in a conventional home freezer or in a grocery dairy freezer while maintaining their free-flowing character. For example, frozen ice cream particles made from liquid formulations having a higher freezing point (i.e., a reduced freeze-point depression) may be stored in higher temperature freezers. The high-temperature formulations may be stored at temperatures between about −10° F. and 0° F., even with an occasional rise to perhaps as much as +5° F. Exemplary formulations that remain free-flowing at higher temperatures are described in U.S. patent application Ser. Nos. 11/701,624 and 11/801,049, the entire contents and disclosure of which are incorporated herein by reference.

At higher temperatures and even at lower temperatures, the plurality of food or ice cream particles may begin to clump or stick together in part due to freezing of water present on the surface of the particles. This causes the product to lose its free-flowing property with other unwanted effects. While the generally spherical or spheroid shape of the particles may contribute to prolonged storage, coating the product may further help to preserve their storage and free-flowing ability by shielding adjacent particles from coalescing, binding or freezing together in addition to providing other benefits such as taste, etc.

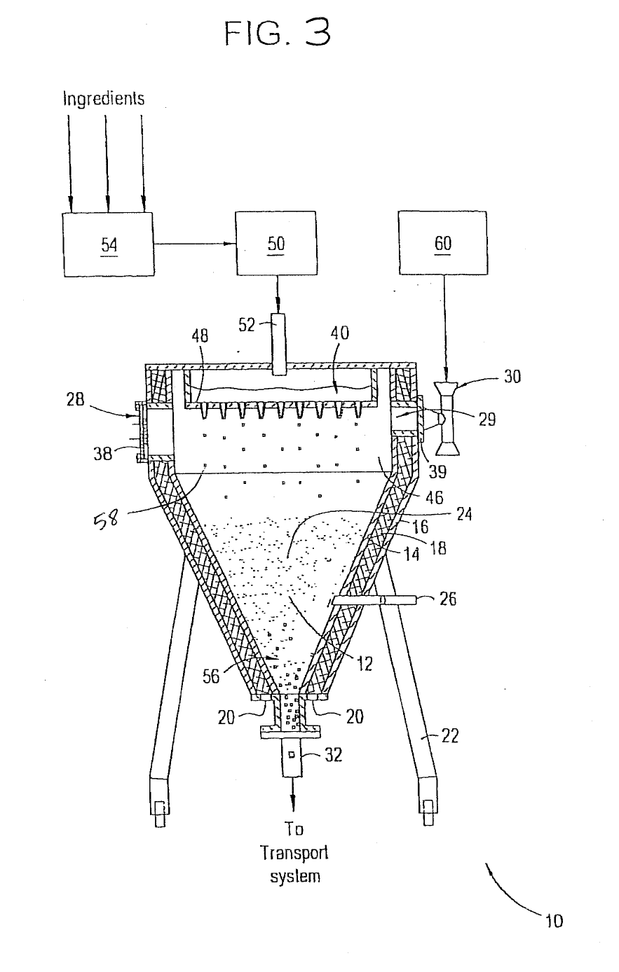

FIG. 3 shows a cryogenic processor constructed in accordance with embodiments of the present invention of forming cryogenically frozen food or ice cream particles or beads 56 from a liquid formulation dripped into the cryogen. A method that may be utilized to produce the product is described in U.S. Pat. No. 5,126,156, the entire contents and disclosure of which is incorporated herein by reference.

According to these embodiments, the container for holding cryogen may be included as part of a cryogenic processor 10 that includes a freezing chamber 12 in the form of a conical tank that holds a liquid refrigerant or cryogen therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant or cryogen 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen beads occurs through product outlet 32 adapted at the base of the freezing chamber 12. An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives a liquid food formulation or composition from a delivery source 50. Typically, a pump (not shown) drives the liquid formulation or composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized food particles or beads 56 of frozen product, uniformly sized droplets 58 of the liquid formulation or composition are fed through gas diffusion chamber 46 to freezing chamber 12. The feed tray 48 is designed with feed assembly 40 that forms droplets 58 of the liquid formulation that fall into the chamber 12. The cryogenically flash frozen food particles or beads are formed when the droplets 58 of liquid composition fall into and contact the refrigerant vapor in the gas diffusion chamber 46, and subsequently the liquid refrigerant 24 in the freezing chamber 12. After these cryogenically frozen beads 56 are formed, they fall or are mechanically directed to the bottom of chamber 12. A transport system connects to the bottom of chamber 12 at outlet 32 to carry the beads 56 to later processing steps and possibly to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow desired.

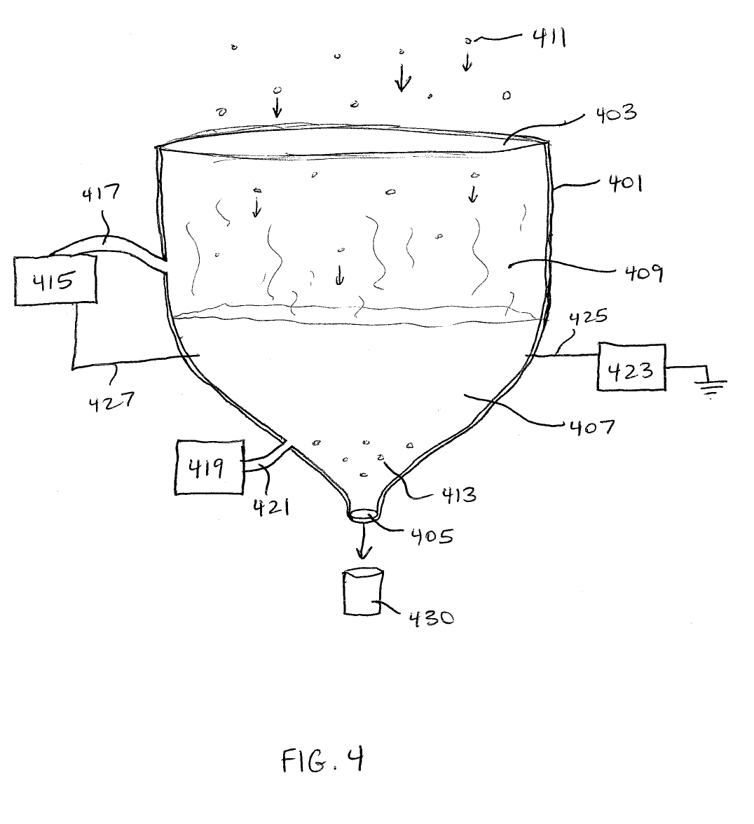

In addition to the methods described herein, an apparatus is further provided for coating the frozen food particles in a cryogenic bath with or without the electric charging. FIG. 4 provides a simplified view of an apparatus according to embodiments of the present invention. A container 401 having a liquid cryogen 407, such as liquid nitrogen, disposed therein that receives a plurality of droplets or pieces of a food formulation 411 that fall, drop or are placed into the liquid cryogen 407 (as indicated by arrows) through a top opening 403 and a cryogen vapor zone 409 above the liquid cryogen 407. As a result of the very cold temperatures of the liquid cryogen 407 and cryogen vapor 409, the plurality of droplets or pieces of a food formulation 411 are converted into a plurality of frozen food particles 413.

Due to the rapid boiling and evaporation of the liquid cryogen 407 in container 401, the liquid cryogen 407 is in a state of violent turbulence that keeps the frozen food particles 413 in constant motion throughout the volume of liquid cryogen 407. While circulating through the liquid cryogen 407, the frozen food particles 413 become coated by granules of a powder present in the liquid cryogen 407 due to their random contact and affinity for one another. After a period of time, the coated food particles 413 may be removed from the container 401. Any manner of removing the food particles 413 from the container 401 is contemplated. According to an embodiment, the food particles 413 may be removed from the container through an optional lower opening 405 present at or near the bottom of the container 401. Alternatively, the bottom of the container 401 may be closed, and coated food particles 413 may be removed by another means (i.e., scooped, poured, etc.) (not shown) with or without the liquid cryogen first being removed or evaporated. Once removed from the container 401, the coated food particles 413 may be transferred to a separate storage container 430.

As mentioned above, the level, amount or volume of liquid cryogen 407 may become too low after a period of time due to evaporation. Thus, the present apparatus may also optionally include a pump 419 or other device for adding or replenishing additional liquid cryogen 407 or cryogen gas into the container 401 through pipe or conduit 421. Any mechanism may be used, and the liquid cryogen 407 may alternatively be added through the top opening 403 of the container 401 (not shown). Another potential benefit achieved by adding the cryogen directly to the bath of liquid cryogen 407 is that it will further increase the mixing of the food particles and powder in the cryogen through increased turbulence. Especially if the food particles 413 tend to settle near the bottom of container 401, a directed flow toward the bottom of the container 401 may help to resuspend these particles 413.

As another feature of embodiments the present invention, an apparatus may further optionally include a dry powder source 415 for adding additional powder to the liquid cryogen in the container 401 through pipe or conduit 417. This may serve the benefit of replenishing the powder as it is being consumed by the coating process. The amount and rate of addition of powder may be controlled to preserve or create a desired concentration of powder in the liquid cryogen 407 by metering a predetermined or calculated amount of powder. For example, a conductance detector 427 may be further provided for detecting the conductivity or other measurement or feedback from the liquid cryogen 407 in container 401 as a basis or indicator of the amount or concentration of powder present in the container 401. Any such measurement or detection may be used to determine when and/or how much powder should be added to the container 401 and liquid cryogen 407. A specific amount of powder may be metered or added into the container 401 by any device known in the art, such as an auger, etc., which may be controlled by a motor and a logic controller or computer, which may form part of dry powder source 415 (not shown).

According to embodiments of the present invention, another optional feature is an electrode placed or positioned to either contact the container 401 or the liquid cryogen 407 directly to deliver a charge to the cryogen 407 and powder from a power supply or source 423 through wire and electrode 425. The wire and electrode 425 may provide either a positive or negative charge to the cryogen 407 and powder depending on the coating process.

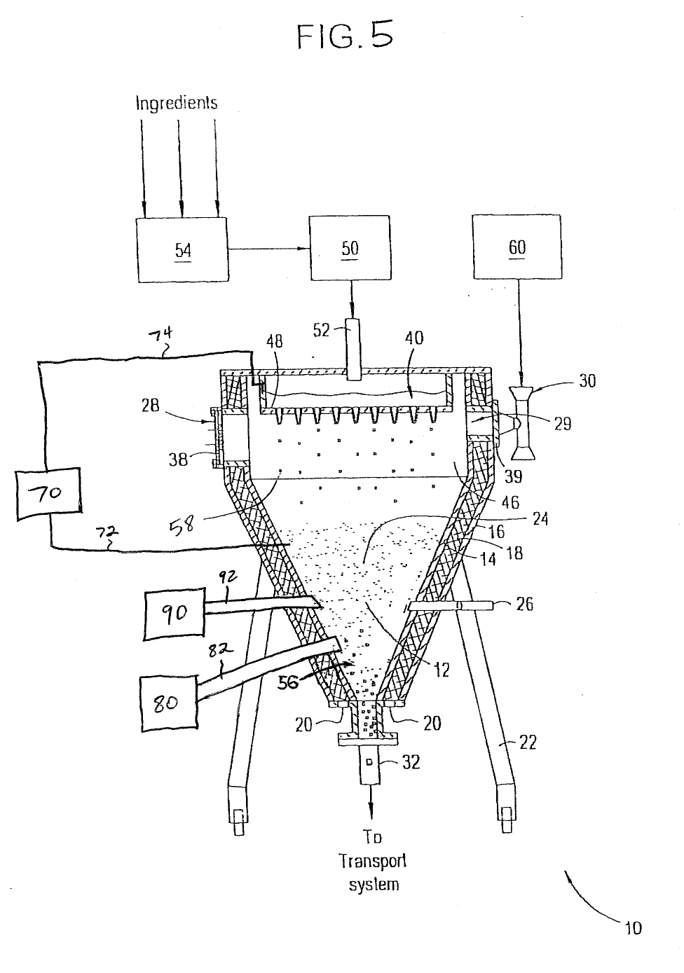

FIG. 5 presents an example of an apparatus according to some embodiments of the present invention similar to FIG. 3 with additional features presented in FIG. 4. Much like the apparatus in FIG. 3, the apparatus in FIG. 5 may be used in forming a plurality of cryogenically frozen ice cream or food particles or beads by flash freezing a liquid formulation in a fluidized cryogen bed or bath. As in FIG. 4, the freezing chamber 12 of cryogenic processor 10 may contain a fluidized bath or bed of cryogen with powder suspended therein for coating the ice cream of food particles as they are formed in the cryogen bath. As shown according to some embodiments, a pump 80 may be used to pump additional cryogen liquid or gas through a delivery route 82 and into the container 12 of processor 10. A dry powder source 90 may also be provided according to some embodiments to deliver powder into the container 12 through its delivery route 92. One of ordinary skill will recognize that there are many functionally equivalent methods to deliver the powder and the cryogen without departing from the scope of the present invention.

As an additional embodiment, the cryogenic processor 10 may also include a first wire and electrode 72 connected to a power supply or source 70 to deliver an electric charge to the cryogen and powder. The wire and electrode 72 may be in contact either with the container 12 or the cryogen 24 directly. The phrase “in contact’ does not require direct physical contact but is intended to mean that the electrodes are in electrical communication, either directly or indirectly, with them. The second wire and electrode 74 from the power source 70 is oppositely charged and may be connected elsewhere to the apparatus or grounded. The power supply 70 is preferably a DC power source such that one electrode is positively charged and the other electrode is negatively charged. The first wire and electrode 72 and the second wire and electrode 74 may each be either positively or negatively charged depending on their arrangement.

According to some embodiments, the second wire and electrode 74 may be attached to a portion of the apparatus that will interact with the liquid food or ice cream formulation that will be dripped into the container 12 and become the food particles 56. This will cause the liquid formulation to adopt an opposite charge in relation to the powder in the cryogen bath, thus increasing the attraction and association between the liquid formulation flash frozen into the food particles 56 and the powder present in the cryogen bath that is oppositely charged by first wire and electrode 72. For example, second wire and electrode 74 may be in contact with the drip tray 48 that will contact and possibly charge the liquid formulation before it is dripped into the container 12.

The previous description is provided to enable any person skilled in the art to practice the various embodiments described herein. Reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

While the present invention has been disclosed with reference to certain embodiments, it will be apparent that modifications and variations are possible without departing from the spirit and scope of the invention as defined in the appended claims. Furthermore, it should be appreciated that all embodiments and examples in the present disclosure, while illustrating these embodiments of the invention, are provided as non-limiting examples and are, therefore, not to be taken as limiting the various aspects so illustrated. The present invention is intended to have the full scope defined by the language of the following claims, and equivalents thereof. Accordingly, the drawings and detailed description are to be regarded as illustrative and not as restrictive.

What is claimed is:

1. A method for powder coating a food particle, comprising:
(a) adding a plurality of pieces or droplets of a food mixture into a liquid cryogen bath in a container to form a plurality of cryogenically frozen food particles; and
(b) coating the plurality of cryogenically frozen food particles with a powder present in the liquid cryogen.

2. The method of claim 1, wherein substantially all of the surface of the plurality of cryogenically frozen food particles are coated with the powder in step (b).

3. The method of claim 1, wherein the cryogen is liquid nitrogen.

4. The method of claim 1, wherein the cryogen in the container is rapidly boiling and turbulent during step (b).

5. The method of claim 1, wherein the food mixture is a liquid formulation of ice cream and the plurality of cryogenically frozen food particles are beaded ice cream.

6. The method of claim 1, wherein the plurality of cryogenically frozen food particles formed in step (a) have a diameter of from about 0.05 inch to about 0.5 inch.

7. The method of claim 1, wherein the plurality of cryogenically frozen food particles remain free-flowing when stored at a temperature between about −10° F. and about 0° F.

8. The method of claim 1, wherein the powder is maltodextrin or cocoa powder.

9. The method of claim 1, further comprising:
(c) electrically charging the powder in the liquid cryogen via a first electrode connected to a direct current (DC) power source, wherein step (c) is performed prior to or during step (b).

10. The method of claim 9, wherein the powder is charged with a positive electrode during step (c).

11. The method of claim 9, wherein the powder is charged with a negative electrode during step (c).

12. The method of claim 9, wherein the first electrode is in contact with the container or the cryogen during step (c).

13. The method of claim 9, wherein the food mixture is charged during step (c) with a second electrode that is connected to the power source, wherein the second electrode has an opposite electric charge than the first electrode.

14. The method of claim 13, wherein the food mixture is a liquid formulation that is dripped into the cryogen as a plurality of droplets from a feed tray in step (a), and wherein the second electrode is connected to the feed tray during step (c).

15. The method of claim 1, further comprising:
(d) adding an additional amount of powder to the cryogen in the container, wherein the amount of powder added in step (d) is metered or controlled.

16. The method of claim 1, further comprising:
(e) adding an additional amount of cryogen to the container.

17. A plurality of powder coated food particles produced by the method of claim 1.

18. An apparatus, comprising:
a container having a top opening and configured to hold a bath of liquid cryogen;
a feed tray disposed above or near the top of the container; and
a first electrode connected to a power source and configured to be in electrical contact with the liquid cryogen when the liquid cryogen is present in the container,
wherein the feed tray is configured to receive a liquid formulation and form a plurality of droplets of the liquid formulation that fall into the liquid cryogen when present in the container.

19. The apparatus of claim 18, further comprising:
a second electrode connected to the power source and configured to be in electrical contact with the feed tray.

20. The apparatus of claim 18, further comprising:
a powder source containing a powder; and
a conduit for delivering an amount of the powder into the container.
